(19) United States
(12) Patent Application Publication
(10) Pub. No.: US 2010/0245735 A1
(43) Pub. Date: Sep. 30, 2010

(54) ARRAY SUBSTRATE AND MANUFACTURING METHOD THEREOF

(75) Inventors: Zhenyu XIE, Beijing (CN); Seung Moo RIM, Beijing (CN); Xu CHEN, Beijing (CN); Xiang LIU, Beijing (CN)

Correspondence Address: LADAS & PARRY LLP, 224 SOUTH MICHIGAN AVENUE, SUITE 1600, CHICAGO, IL, 60604, US

(73) Assignee: BEIJING BOE OPTOELECTRONICS TECHNOLOGY CO., LTD., Beijing (CN)

(21) Appl. No.: 12/732,884

(22) Filed: Mar. 26, 2010

(30) Foreign Application Priority Data
Mar. 27, 2009 (CN) 200910080900.0

(51) Int. Cl. G02F 1/1333; G02F 1/1343

(52) U.S. Cl. 349/110; 349/139

(57) ABSTRACT

An array substrate comprises a substrate; a plurality of pixel regions in a matrix arrangement on the substrate, and a plurality of signal lines disposed on the substrate and extended parallel to each other. Each pixel region comprises a pixel electrode and a drive switch. At least part of a first signal line and a second signal line of the plurality of the signal lines connected to pixel electrodes in adjacent lines of the pixel region matrix are formed between the pixel electrodes in adjacent lines of the pixel regions matrix. The first signal line and the second signal line are at least partially overlapped in a direction perpendicular to the substrate. An insulating layer is disposed between the overlapped portion of the first and second signal line.

### BACKGROUND

The present invention relates to liquid crystal display (LCD), in particular to an array substrate in a LCD and manufacturing method thereof, and a LCD with the array substrate.

Aperture ratio is one of the important indicators for display quality of LCD. The aperture ratio refers to ratio of transmissive area to overall area in a unit pixel region. The higher the aperture ratio, the higher light transmission for the unit pixel region is, which in turn will improve the brightness of LCD with the same backlight. Therefore, high aperture ratio is one of the trends for thin film transistor liquid crystal display (TFT-LCD) development.

FIG. 1 is a partial schematic top view of the a conventional array substrate in a TFT-LCD, FIG. 2 s a cross-sectional view taken along line A-A in FIG. 1. The array substrate comprises a substrate 1 with unit pixel regions in a matrix arrangement. A pixel electrode and a drive switch are disposed in each unit pixel region. The drive switch can be a TFT switch in the TFT-LCD, for example. A plurality of data lines 3 and a plurality of gate line 2 are disposed on the substrate 1 so as to cross each other and insulated from each other via a gate insulating layer 6. The data lines 3 and the pixel electrodes 13 are insulated from each other via a passivation layer 11. The pixel electrodes 13 are electrically disconnected from each other. Each pixel electrode 13 is connected to the adjacent data line 3 and the gate line 2 via a respective TFT switch. The TFT switch can comprise a gate electrode 4, a source electrode 9, a drain electrode 10, a semiconductor layer 7 and a doped semiconductor layer 8. As shown in FIGS. 1 and 2, the plurality of gate lines horizontally disposed on the substrate 1. The gate electrode 4 and gate line 2 are disposed in a same layer and connected to each other. Alternatively, the gate electrode 4 can be a part of gate line 2. Typically, common electrode lines can be disposed in the same layer as the gate lines 2 and extended vertically on the substrate 1 in order to provide common voltage. The gate electrode 4 and the gate lines 2 are covered by the gate insulating layer 6. The semiconductor layer 7, the doped semiconductor 8, the source electrode 9, the drain electrode 10 and a plurality of data lines 3 extending vertically are disposed on the gate insulating layer 6. The doped semiconductor layer 8 is positioned above the semiconductor 7. The source electrode 9 is connected to the date line 3. The drain electrode 10 is connected to the pixel electrode 13. The source electrode 9 and the drain electrode 10 are disposed on opposite ends of the doped semiconductor layer 8 with TFT channel formed therebetween. The source electrode 9, the drain electrode 10 and data lines 3 are covered by the passivation layer 11. The pixel electrode 13 is formed on the passivation layer 11 and connected to the drain electrode via the passivation through hole formed in the passivation layer 11. As shown in FIG. 1, the horizontal gate lines 2 and vertical data lines cross each other and divide the array substrate into a plurality of unit pixel regions. The regions where TFT switches, data lines 3 and gate lines 2 are located are covered by a black matrix on a color filter substrate in the LCD, thereby blocking lights. The area other than the black matrix in LCD is a transmissive region, which determines the aperture ratio.

Therefore, the area taken by the black matrix is a main factor affecting the aperture ratio. That is, the larger the area taken by the data lines 3 and the gate lines 2 is, the smaller the aperture ratio is.

In design of the array substrate of the TFT-LCD, the aperture ratio is estimated in advance according to prescribed display area and resolution. A design value of the aperture ratio can be calculated from the layout design of the unit pixel region and the black matrix. The estimated aperture ratio is then compared with the design value. If the design value of the aperture ratio is too low, the aperture ratio can be improved by reducing effective widths of the gate lines and the data lines and the spacing between the gate lines and the data lines and the pixel electrode with different design for storing capacitors and the black matrix. However, the reduced effective width of data lines and gate lines might increase resistivity along the lines and increase RC delay and degrade display quality.

### SUMMARY

The embodiments of the present invention provide an array substrate and a manufacturing method thereof with improved aperture ratio.

According to one aspect of the present invention, there is provided an array substrate comprising a substrate; a plurality of pixel regions in a matrix arrangement on the substrate, and a plurality of signal lines disposed on the substrate and extended parallel to each other. Each pixel region comprises a pixel electrode and a drive switch. At least part of a first signal line and a second signal line of the plurality of the signal lines connected to pixel electrodes in adjacent lines of the pixel region matrix are formed between the pixel electrodes in adjacent lines of the pixel regions matrix. The first signal line and the second signal line are at least partially overlapped in a direction perpendicular to the substrate. An insulating layer is disposed between the overlapped portion of the first and second signal line.

In one embodiment, the signal lines are data lines, the first and second signal line are a first and second data line connected to pixel electrodes in adjacent columns of the pixel region matrix, and the insulating layer is a first insulating layer.

Furthermore, the first data line is at least partially disposed below the second data line. The pixel electrode is formed above the first insulating layer and the second data line. The array substrate further comprises a second passivation layer formed above the first insulating layer and covering the second data line.

Furthermore, the first data line and the second data line are formed above a gate insulating layer of the drive switch. The first data line is formed in a same layer as a source electrode of the drive switch connected thereto and the second data line is formed in a same layer as a source electrode of the drive switch connected thereto.

In another embodiment, the array substrate can further comprise a plurality of gate lines crossing the plurality of data lines. At least part of a first gate line and a second gate line of the plurality of the gate lines connected to pixel electrodes in adjacent rows of the pixel region matrix are formed between the pixel electrodes in adjacent rows of the pixel region matrix. The first gate line and the second gate line are at least partially overlapped in a direction perpendicular to the substrate. A second insulating layer is disposed between the overlapped portion of the first and second gate line.

Furthermore, the first gate line and the second line are covered by a gate insulating film.

Furthermore, the first gate line is formed in a same layer as a gate electrode of the drive switch connected thereto and the second gate line is formed in a same layer as a gate electrode of the drive switch connected thereto.

In yet another embodiment, the signal lines are gate lines, the first and second signal line are a first and second gate line connected to pixel electrodes in adjacent rows of the pixel region matrix, and the insulating layer is a second insulating layer.

Furthermore, the first gate line and the second line are covered by a gate insulating film. The first gate line and the second line are formed in a same layer as a gate electrode of drive switch.

According to another aspect of the present invention, there is provided a manufacturing method of an array substrate. The method can comprise the following steps: a gate metal layer is deposited on a substrate; a gate electrodes and a gate lines are formed by etching the gate metal layer in a patterning process; a gate insulating layer is deposited on the substrate; a semiconductor material layer, a doped semiconductor material layer and a metal layer are sequentially deposited on the gate insulating layer; the semiconductor material layer, the doped semiconductor material layer and the metal layer are patterned by etching so as to form a semiconductor layer, a doped semiconductor layer, a first source electrode, a first drain electrode, a first data line, a second source electrode and a second drain electrode in unit pixel regions in adjacent columns; the first data line is formed between unit pixel regions in adjacent columns, a first source electrode is connected to the first data line; a first insulating layer is deposited on the substrate, and through holes are formed in the first insulating layer corresponding to the first drain electrode, the second drain electrode and a second source electrode, respectively; and a metal layer and a transparent conductive material layer are deposited on the first insulating layer and are etched in a patterning process to form a second data line and a pixel electrode, the second data line and the first data line are at least partially overlapped in a direction perpendicular to the substrate, the pixel electrode is connected to the first drain electrode and the second drain electrode the via through holes in the first insulating layer, respectively, and the second data line is connected to the second source electrode via the through hole in the first insulating layer.

In particular, the step of forming a second data line and a pixel electrode can further comprise following steps: the metal layer is deposited on the first insulating layer and etched in a patterning process to form the second data line, a second passivation layer is deposited on the substrate, covering the second data line, and through holes are formed in the second passivation layer corresponding to the first drain electrode and the second drain electrode, respectively; a transparent conductive layer is deposited on the second passivation layer; the transparent conductive layer is etched in a patterning process to form a pixel electrode, the pixel electrode is connected to the first drain electrode and the second drain electrode via the through holes in the first insulating layer and the second passivation layer.

In another embodiment, the step of depositing the gate metal layer and forming the gate electrode and the gate line can further comprise following steps: a first gate metal layer is deposited on a substrate; the first gate metal layer is etched in a patterning process to form the first gate electrode and the first gate line, the first gate line is formed between the pixel regions in adjacent rows; a second insulating layer is deposited on the substrate; a second gate metal layer is deposited on the second insulating layer; the second metal layer is etched in a patterning process to form a second gate electrode and a second gate line, the second gate line and the first gate line are partially overlapped in a direction perpendicular to the substrate.

In yet another embodiment, there is provided a manufacturing method of an array substrate. The method can comprise the following steps: the a gate metal layer is deposited on substrate; the gate metal layer is etched in a patterning process to form the gate electrode and the gate line; a gate insulating layer is deposited on the substrate; a semiconductor material layer, a doped semiconductor material layer and a metal layer are deposited sequentially on the gate insulating layer; the semiconductor material layer, the doped semiconductor material layer and the metal layer are etched in a patterning process to form the semiconductor layer, the doped semiconductor layer and the first data line in pixel regions in adjacent columns, the first data line is formed between the pixel regions in adjacent columns, and the first data line can extend onto the doped semiconductor layer; a first insulating layer is deposited on the substrate and through holes are formed in the first insulating layer corresponding to the first source electrode, the first drain electrode, the second source electrode and the second drain electrode, respectively; a metal layer is deposited on the first insulating layer and patterned to form the first source electrode, the first drain electrode, the second source electrode and the second drain electrode and the data line; the first source electrode is connected to a protruded portion of the first data line via the through hole in the first insulating layer, the first drain electrode, the second source electrode and the second drain electrode are connected to the doped semiconductor layer via the through holes, the second data line and the first data line are partially overlapped in a direction perpendicular to the substrate 1, and the first source electrode and the second source electrode are disposed on both sides of the second data line, respectively; a transparent conductive material layer is deposited and patterned to form the pixel electrode, the pixel electrode is connected to the first drain electrode and the second electrode, respectively.

In yet another embodiment, there is provided a manufacturing method of an array substrate. The method can comprise the following steps: a first gate metal layer is deposited on a substrate; the first gate metal layer is etched in a patterning process to form the first gate electrode and the first gate line, the first gate line is formed between the pixel regions in adjacent rows; a second gate insulating layer is deposited on the substrate; a second gate metal layer is deposited on the second insulating layer; the second metal layer is etched in a patterning process to form a second gate electrode and a second gate line, the second gate line and the first gate line are partially overlapped in a direction perpendicular to the substrate; a gate insulating layer is deposited on the substrate; a semiconductor material layer, a doped semiconductor material layer and a metal layer are deposited on the gate insulating layer; the semiconductor material layer, the doped semiconductor material layer and the metal layer are etched in a patterning process to form a semiconductor layer, a doped semiconductor layer, a source electrode, a drain electrode and a data line; a passivation layer is deposited on the substrate and a through hole is formed in the passivation layer corresponding to the drain electrode; a transparent conductive material layer is deposited on the passivation layer; the transparent conductive material layer is etched in a patterning process to form a pixel electrode, and the pixel electrode is connected to the drain electrode via a through hole in the passivation layer.

According to yet another aspect of the present invention, there is provided a manufacturing method of an array substrate. The method can comprise the following steps: a plurality of pixel regions in a matrix arrangement are formed on the substrate, each pixel region comprising a pixel electrode and a drive switch; and a plurality of signal lines are disposed on the substrate and extended parallel to each other. At least part of a first signal line and a second signal line of the plurality of the signal lines connected to pixel electrodes in adjacent lines of the pixel region matrix are formed between the pixel electrodes in adjacent lines of the pixel regions matrix, the first signal line and the second signal line are at least partially overlapped in a direction perpendicular to the substrate, an insulating layer is disposed between the overlapped portion of the first and second signal line.

According to yet another aspect of the present invention, there is provided a liquid crystal display panel, which can comprise an array substrate, a color filter substrate with a black matrix disposed thereon, and a liquid crystal layer filled between the array substrate and the color filter substrate. The array comprises a substrate; a plurality of pixel regions in a matrix arrangement on the substrate; and a plurality of signal lines disposed on the substrate and extended parallel to each other. Each pixel region comprises a pixel electrode and a drive switch. At least part of a first signal line and a second signal line of the plurality of the signal lines connected to pixel electrodes in adjacent lines of the pixel region matrix are formed between the pixel electrodes in adjacent lines of the pixel regions matrix, the first signal line and the second signal line are at least partially overlapped in a direction perpendicular to the substrate, an insulating layer is disposed between the overlapped portion of the first and second signal line;

The black matrix comprises a plurality of first light blocking bars and a plurality of second light blocking bars alternatively disposed, the first bars are disposed above the signal lines, so that the width of the first bars is larger than the second bars without underlying the signal lines.

Since the data lines and/or gate lines are overlapped in the array substrate, the area of data lines and/or gate lines covered by the black matrix can be reduced, thus improving the aperture ratio and display quality of the LCD.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the following detailed description.

### BRIEF DESCRIPTION OF THE DRAWINGS

The present invention will become more fully understood from the detailed description given hereinafter and the accompanying drawings which are given by way of illustration only, and thus are not limitative of the present invention and wherein:

FIG. 1 is a schematic partial top view of a conventional array substrate in a TFT-LCD;

FIG. 2 is a cross-sectional view along line A-A in FIG. 1;

FIG. 3 is a schematic partial top view of a first embodiment of an array substrate according to the present invention;

FIG. 4 is a cross-sectional view along line B-B in FIG. 3;

FIG. 5 is a cross-sectional view along line C-C in FIG. 3;

FIG. 6 is a cross-sectional view along line D-D in FIG. 3;

FIG. 7 is a schematic partial top view of a second embodiment of an array substrate according to the present invention;

FIG. 8 is a cross-sectional view along line E-E in FIG. 7;

FIG. 9 is a cross-sectional view along line F-F in FIG. 7;

FIG. 10 is a cross-sectional view along line L-L in FIG. 7;

FIG. 11 is a schematic partial top view of a third embodiment of an array substrate according to the present invention;

FIG. 12 is a cross-sectional view along line G-G in FIG. 11;

FIG. 13 is a schematic partial top view of a fourth embodiment of an array substrate according to the present invention;

FIG. 14 is a cross-sectional view along line H-H in FIG. 13;

FIG. 15 is a schematic partial top view of an array substrate according to an embodiment of the present invention;

FIG. 16 is a flow chart of a first embodiment of a manufacturing method of an array substrate according to the present invention;

FIG. 17 is a schematic partial top view of a structure formed during a first embodiment of a manufacturing method of an array substrate according to the present invention;

FIG. 18 is a cross-sectional view along line I-I in FIG. 17;

FIG. 19 is a schematic partial top view of a structure formed during a first embodiment of a manufacturing method of an array substrate according to the present invention;

FIG. 20 is a cross-sectional view along line J-J in FIG. 19;

FIG. 21 is a cross-sectional view along line K-K in FIG. 19;

FIG. 22 is a flow chart of a second embodiment of a manufacturing method of an array substrate according to the present invention;

FIG. 23 is a flow chart of a third embodiment of a manufacturing method of an array substrate according to the present invention; and

FIG. 24 is a flow chart of a fourth embodiment of a manufacturing method of an array substrate according to the present invention.

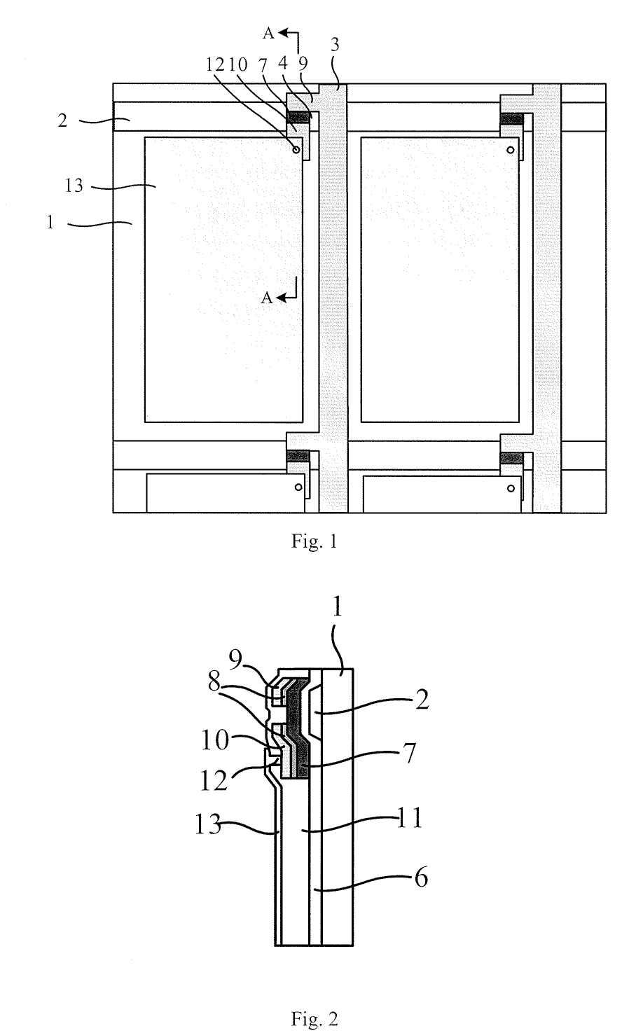

### DETAILED DESCRIPTION OF THE PREFERRED EMBODIMENTS

The embodiments of the present invention are described hereafter in more details in conjunction with accompanying drawings.

First Embodiment of Array Substrate

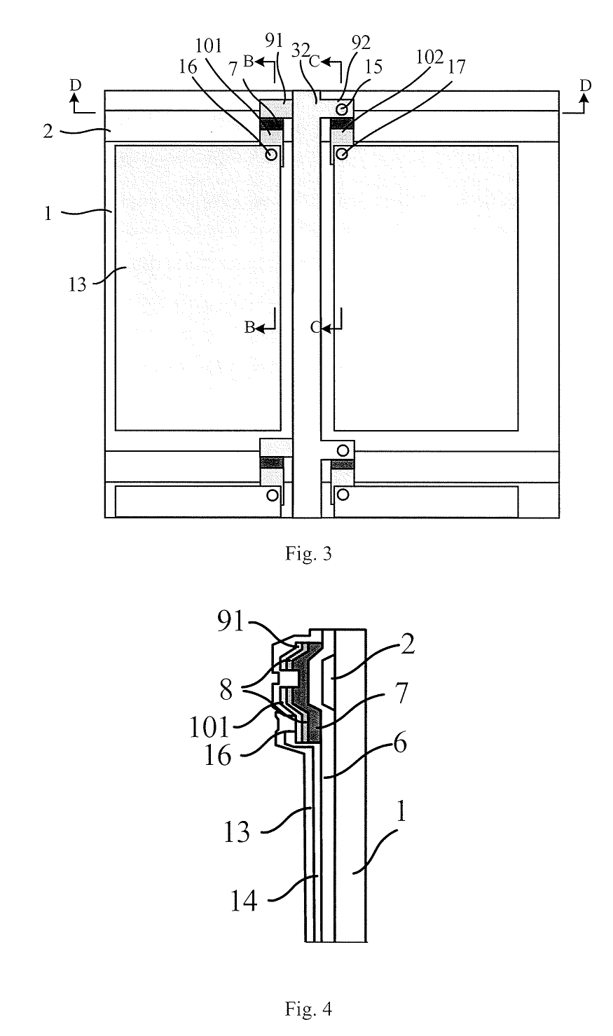

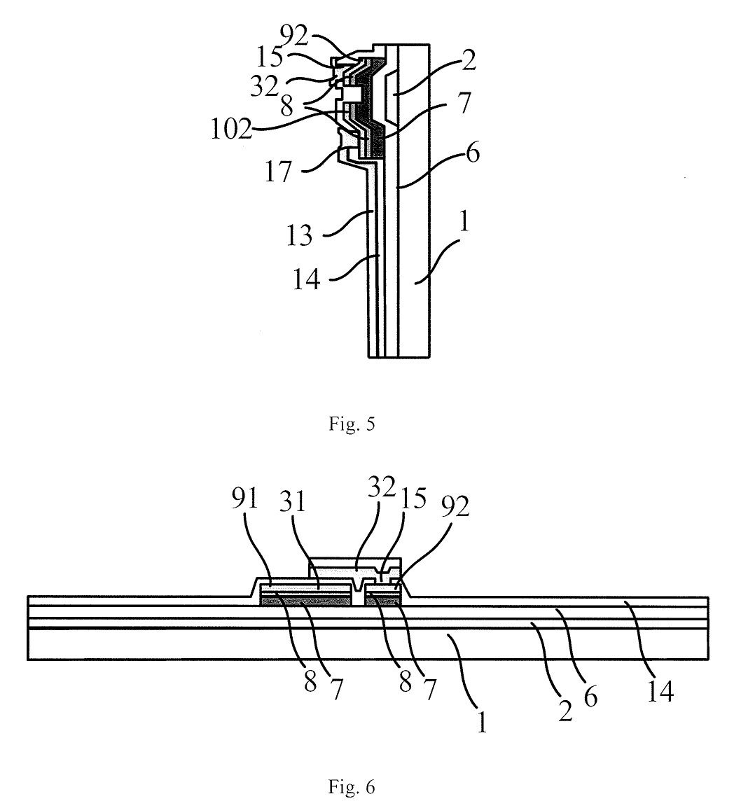

FIG. 3 is a schematic partial top view of a first embodiment of an array substrate according to the present invention, FIG. 4 is a cross-sectional view along line B-B in FIG. 3, FIG. 5 is a cross-sectional view along line C-C in FIG. 3, and FIG. 6 is a cross-sectional view along line D-D in FIG. 3. Insulating layers such as gate insulating layer, passivation layer are not shown throughout top views in the present invention. As shown in FIG. 3, the array substrate comprises a substrate 1 with unit pixel regions formed thereon in a matrix arrangement. A pixel electrode and a drive switch are disposed in each unit pixel region. The drive switch can be a TFT switch in the TFT-LCD, for example. A plurality of data lines 3 and a plurality of gate line 2 are disposed on the substrate 1. The data lines 3, the gate lines 2 and the pixel electrodes 13 are insulated from each other. Each pixel electrode 13 is connected to the adjacent data line 3 and the gate line 2 via a respective drive switch, in particular a TFT switch in a TFT-LCD.

The TFT switch can comprise a gate electrode, a source electrode, a drain electrode, a semiconductor layer 7 and a doped semiconductor layer 8. The gate electrode and an adjacent gate line 2 are connected and disposed in a same layer. Alternatively, the gate electrode can be a part of gate line 2 or can be a part protruded from the gate line 2. Typically, common electrode lines can be disposed in the same layer as the gate lines 2 so as to provide common voltage. The gate electrode and the gate lines 2 are covered by the gate insulating layer 6.

The semiconductor layer 7, the doped semiconductor 8, the source electrode, the drain electrode and a plurality of data lines 3 extending vertically are disposed on the gate insulating layer 6. The source electrode, the drain electrode and the data lines can be made of a same metal material with low resistivity. The doped semiconductor layer 8 is overlapped with the semiconductor layer 7 above the insulating layer 6. At least part of doped semiconductor layer 8 and at least part of the semiconductor lay 7 are overlapped with at least a part of gate electrode.

The source electrode and the drain electrode are disposed on opposite ends of the doped semiconductor layer 8 with TFT channel formed therebetween. The source electrode is connected to an adjacent data line. The source electrode, the drain electrode, the semiconductor layer 7 and the doped semiconductor layer 8 are covered by the first insulating layer 11. The drain electrode is connected to an adjacent pixel electrode 13. The first insulating layer 14 can be made of an insulating material with low dielectric. The pixel electrode 13 can be formed of a transparent conductive material such as ITO.

In the present embodiment, as shown in FIG. 3-6, at least part of two data lines connected with pixel electrodes in adjacent columns are formed between the adjacent pixel electrodes in adjacent columns and the two data lines are at least partial overlapped in a direction perpendicular to the surface of the substrate 1. The first insulating layer is disposed between the overlapped portions of the two data lines.

As shown in FIG. 3-6, the two data lines are referred as the first data line 31 and the second data line 32. The first and the second data line 31 and 32 are formed directly on or above the gate insulating layer 6, and the first insulating layer 14 is formed between the first data line 31 and the second data line 32. The source electrode connected to the first data line is referred as the first source electrode 91, which is formed at a same layer as the first data line. The second data line 32 connected to the source electrode is referred as the second source electrode 92, which is connected to the second data line 32 via a through-hole 15 formed in the first insulating layer 14.

In the present embodiment, the first data line 31 can be at least partially overlapped with the second data line 32. In that case, the first data line 31 is formed between the gate insulating layer 6 and the first insulating layer 14, and the second data line 32 is formed above the first insulating layer 13. The first source electrode 91 connected to the first data line 91 and the respective first drain electrode 101, as well as the second source electrode 92 connected to the second data line 92 and the respective second drain electrode 102 are formed in the same layer as the first data line 31. The pixel electrode 13 is formed above the first insulating layer 13 and the first drain electrode 101 and connected to the first drain electrode 101 via a through-hole 17 formed in the first insulating layer 14. The transparent conductive material of the pixel electrode 13 can be further extended over the second data line 32 without affecting the operation of the second data line 32.

In the present embodiment, the semiconductor layer 7, the doped semiconductor layer 8 can be patterned with the first data line 31 in an etching process with a single mask. Alternatively, the semiconductor layer 7 and the doped semiconductor layer 8 can be patterned in a separate process.

Since the data lines are overlapped in the present embodiment, the area of data lines covered by the black matrix can be reduced, thus improving the aperture ratio and display quality of the LCD.

Second Embodiment of Array Substrate

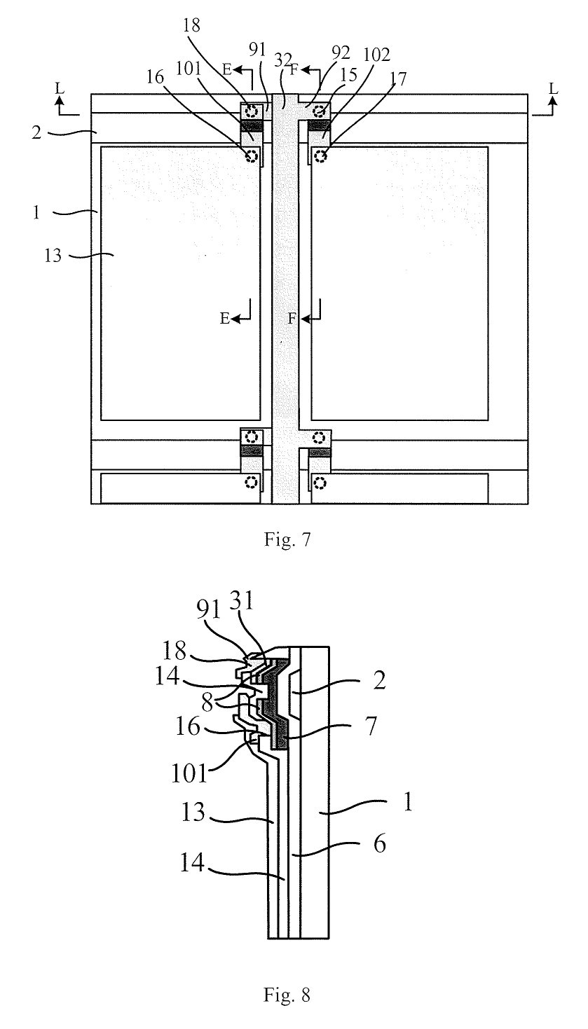

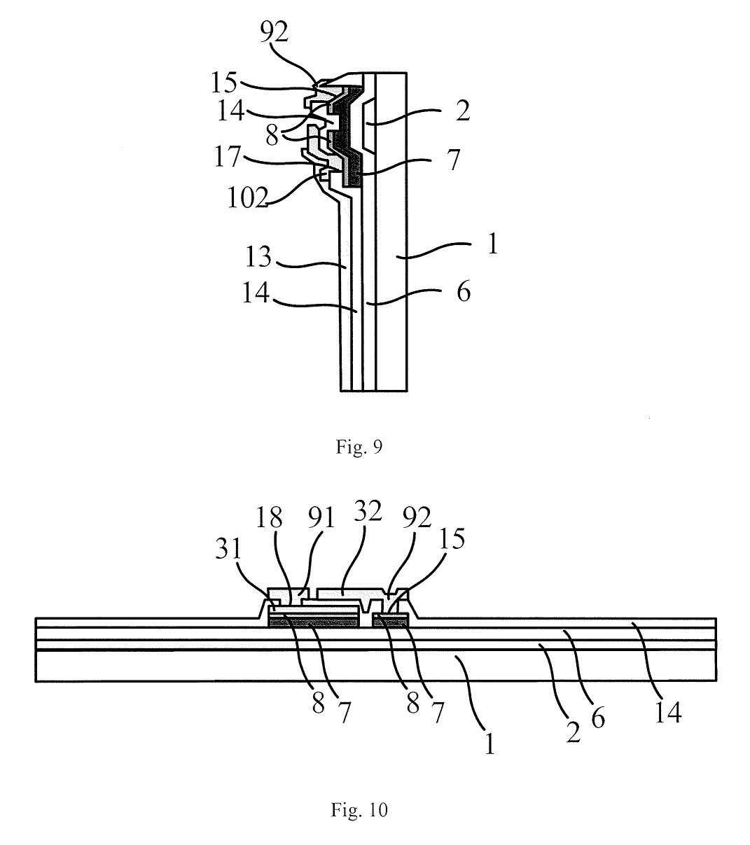

FIG. 7 is a schematic partial top view of a second embodiment of an array substrate according to the present invention; FIG. 8 is a cross-sectional view along line E-E in FIG. 7; FIG. 9 is a cross-sectional view along line F-F in FIG. 7; and FIG. 10 is a cross-sectional view along line L-L in FIG. 7. The first data line 31 is disposed below the second data line 32 in the present embodiment. The second embodiment is different from the first embodiment in that, the first source electrode 91, the first drain electrode 101, the second source electrode 92 and the second drain electrode 102 are formed above the first insulating layer 13 at the same layer as the second data line 32.

In the present embodiment, the first data line 31 comprises a protruded part extending over the doped semiconductor layer 8. The protruded part is connected to the first source electrode 91 via a through-hole 18 formed in the first insulating layer 14, and the first drain electrode 101 is connected to the doped semiconductor layer 8 via a through hole 16 in the first insulating layer 14. The second data line 32 is directly connected to the second source electrode 92 and the second source electrode 92 is connected to the doped semiconductor layer 8 via a through hole 15 in the first insulating layer 14, and the second drain electrode 102 is connected to the doped semiconductor layer 8 via a through hole 17 in the first insulating layer 14. The pixel electrode 13 is directly connected to both first and second drain electrode 101 and 102.

The semiconductor layer 7 and the doped semiconductor layer 8 can be formed above the gate insulating layer 6 and below the first data line 31. Alternatively, the semiconductor layer 7 and the doped semiconductor layer 8 can be formed on the first gate insulating layer 6 to directly connect to the source and drain electrode, and the first data line 31 is connected to the first source electrode 91 via a through hole 18 in the first insulating layer 14.

Since the data lines are overlapped in the present embodiment, the area of data lines covered by the black matrix can be reduced, thus improving the aperture ratio and display quality of the LCD.

In the above embodiments, the source electrode and the drain electrode are not limited to be formed at the same layer as the data line connected thereto. Alternatively, the first source electrode, the first drain electrode and the first data line can also be formed at a same layer, the second source electrode, the second drain electrode and the second data line can also be formed at a same layer and the pixel electrode is connected to the drain electrodes at a different level via through hole in the first insulating layer. The first embodiment might be better than the second embodiment in view of manufacturing process.

Third Embodiment of Array Substrate

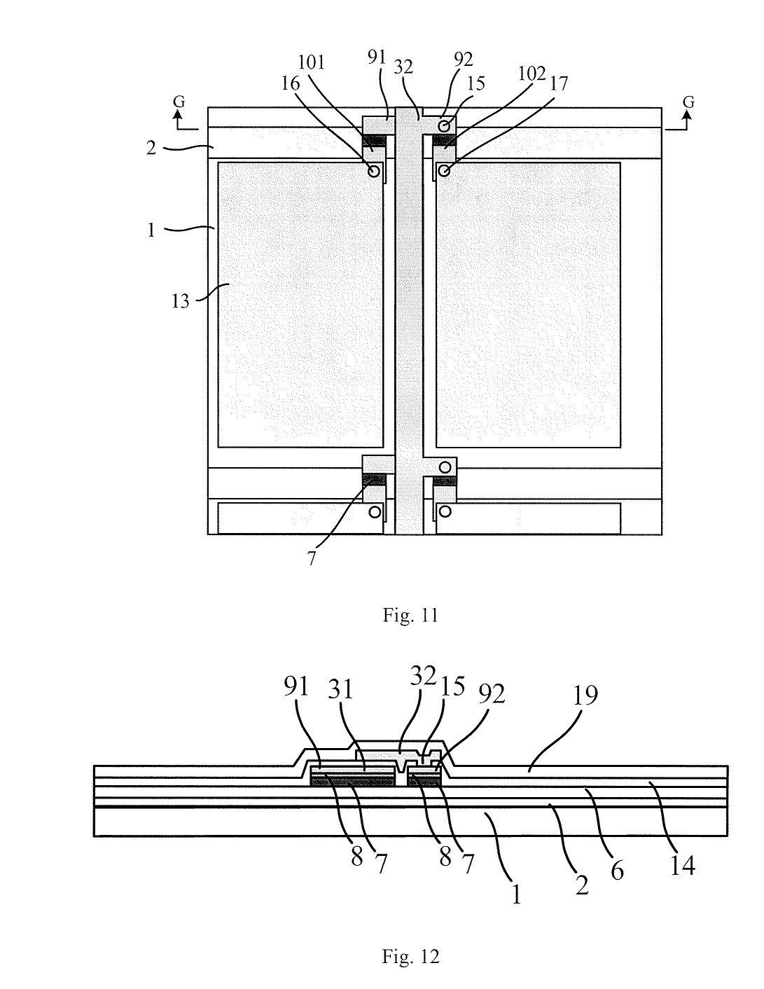

FIG. 11 is a schematic partial top view of a third embodiment of an array substrate according to the present invention. FIG. 12 is a cross-sectional view along line G-G in FIG. 11. In the present embodiment, the first data line 31 is at least partially overlapped with the second data line 32. The array substrate can further comprise a second passivation layer 19 formed on the first insulating layer 13 to cover the second data line 32. The pixel electrode 13 is formed on the second passivation layer 19 and connected to the first and second drain electrode 101 and 102 via through holes in the second insulating layer 19.

Since the data lines are overlapped in the present embodiment, the area of data lines covered by the black matrix can be reduced, thus improving the aperture ratio and display quality of the LCD. In addition, the second passivation layer can completely separate the pixel electrode and the second data line, thus improving reliability of the LCD.

The features in the third embodiment can be also incorporated into the second embodiment, for example, the pixel electrode can be connected to the drain electrodes only via the through holes in the second passivation layer.

Fourth Embodiment of Array Substrate

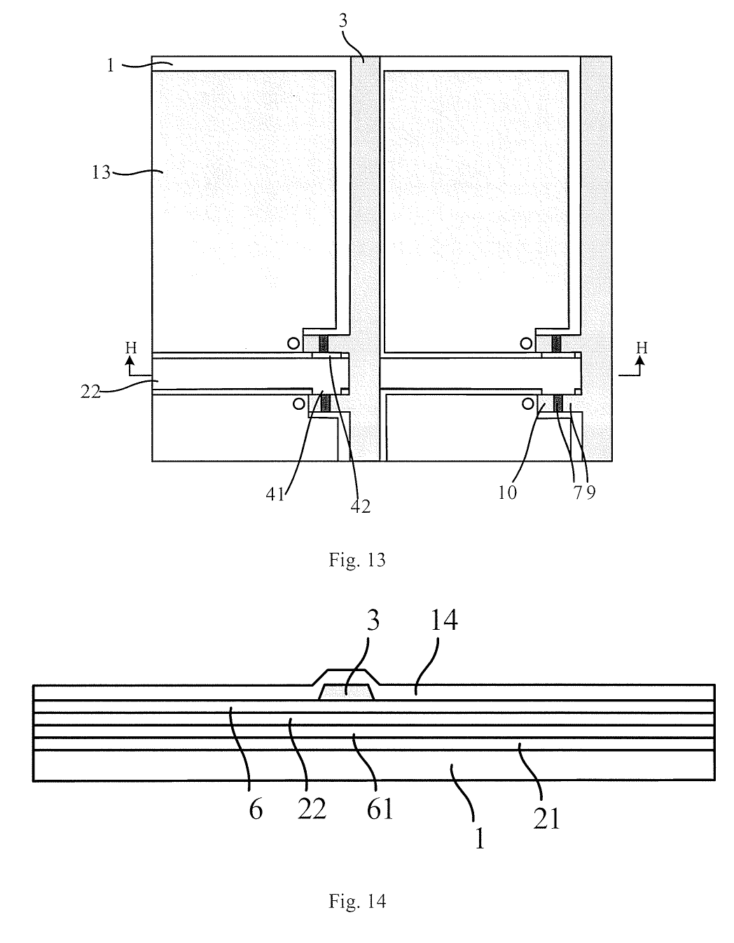

FIG. 13 is a schematic partial top view of a fourth embodiment of an array substrate according to the present invention. FIG. 14 is a cross-sectional view along line H-H in FIG. 13. In the present embodiment, the data lines 3 can be disposed separately or superposed. The present embodiment is different from the first embodiment in that, at least part of two gate lines connected to the pixel electrodes 13 in adjacent rows are formed between the pixel electrodes 13 in adjacent rows and the two gate lines are at least partially overlapped in a direction perpendicular to the substrate 1. The second insulating layer 61 is disposed between the overlapped portions of the two gate lines.

In particular, the two gate lines are referred as the first gate line 21 and the second gate line 22. The first gate line 21 and the first gate 31 connected thereto are formed at a same layer above the substrate 1 and covered by the second insulating layer 61. The second gate line 22 and the first gate 42 connected thereto are formed at a same layer above the second insulating layer 61 and covered by the gate insulating layer 6. In the present embodiment, the second insulating layer 61 can be another gate insulating layer to insulate the first gate line 21 and the second gate line 22.

The gate electrode can also be connected to the gate line via a through hole in the gate insulating layer. However, it is better to form the connected gate line and gate electrode at the same layer, or form the gate electrode as a part of the gate line in view of the manufacturing process.

Since the gate lines are overlapped in the present embodiment, the area of gate lines covered by the black matrix can be reduced, thus improving the aperture ratio and display quality of the LCD.

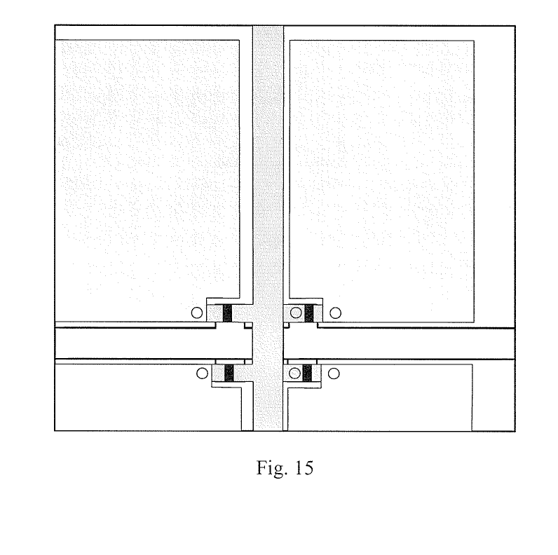

In the above embodiments, the drive switch is not limited to TFT switch. It is also possible to combine the overlapped data lines and the overlapped gate lines in one embodiment, as shown in FIG. 15, thus greatly improving the aperture ratio.

First Embodiment of Manufacturing Method of an Array Substrate

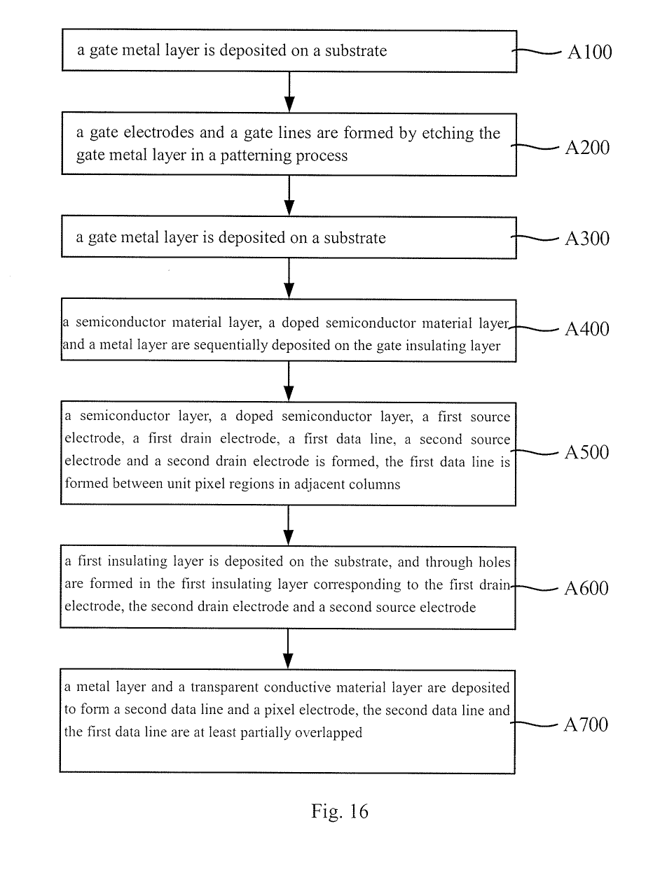

FIG. 16 is a flow chart of a first embodiment of a manufacturing method of an array substrate according to the present invention. The method comprises following steps:

step A100, a gate metal layer is deposited on a substrate 1;

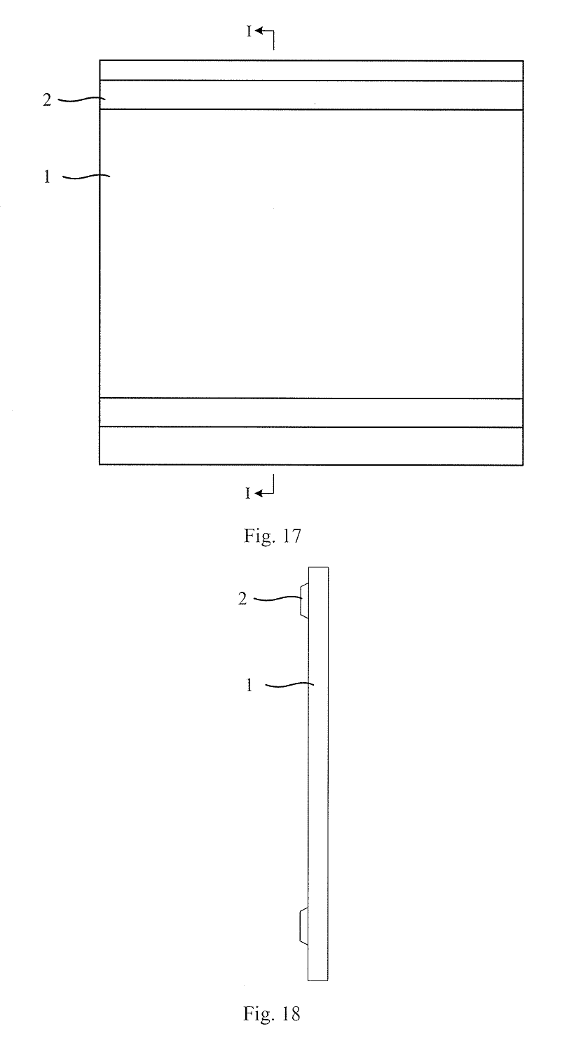

step A200, a gate electrode and a gate line 2 are formed by etching the gate metal layer in a patterning process, the gate electrode is a part of the gate line 2, as shown in FIGS. 17 and 18, (FIG. 17 is a schematic partial top view of a structure formed during a first embodiment of a manufacturing method of an array substrate according to the present invention. FIG. 18 is a cross-sectional view along line I-I in FIG. 17);

step A300, a gate insulating layer 6 is deposited on the substrate 1, the gate insulating layer 6 can be formed of silicon nitride (SiNx);

step A400, a semiconductor material layer, a doped semiconductor material layer and a metal layer are sequentially deposited on the gate insulating layer 6, the semiconductor material layer can be formed of amorphous silicon (a-Si) and the doped semiconductor material layer can be formed of n type amorphous silicon (n+a-Si);

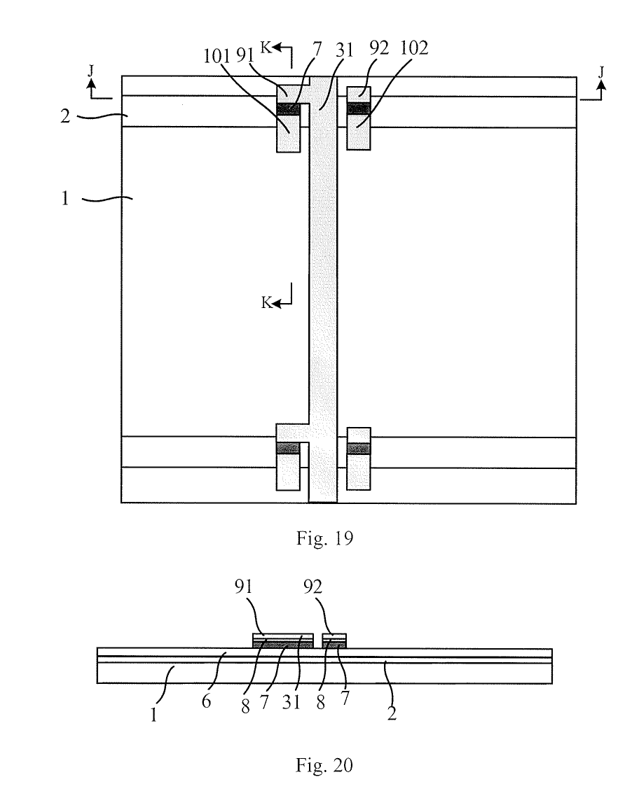

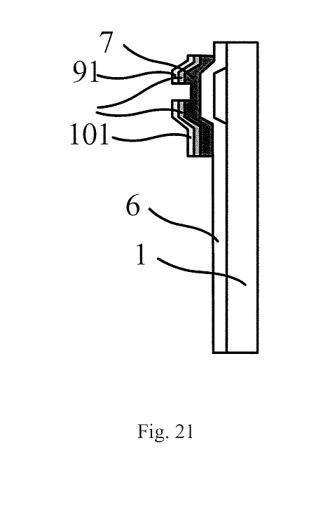

step A500, the semiconductor material layer, the doped semiconductor material layer and the metal layer are patterned by etching so as to form a semiconductor layer 7, a doped semiconductor layer 8, a first source electrode 91, a first drain electrode 101, a first data line 31, a second source electrode 92 and a second drain electrode 102 in unit pixel regions in adjacent columns; the first data line 31 is formed between unit pixel regions in adjacent columns, a first source electrode 91 is connected to the first data line 31, as shown in FIGS. 19, 20 and 21, (FIG. 19 is a schematic partial top view of a structure formed during a first embodiment of a manufacturing method of an array substrate according to the present invention; FIG. 20 is a cross-sectional view along line J-J in FIG. 19; FIG. 21 is a cross-sectional view along line K-K in FIG. 19);

step A600, a first insulating layer 14 is deposited on the substrate 1, then through holes 16, 17 and 15 are formed in the first insulating layer 14 corresponding to the first drain electrode 101, the second drain electrode 102 and a second source electrode 92, respectively; and

step A700, a metal layer and a transparent conductive material layer can be sequentially deposited on the first insulating layer 14, a second data line 32 and a pixel electrode 13 can be formed by etching in two separate patterning processes; alternatively, a transparent conductive material layer and a metal layer can be sequentially deposited and patterned to form the second data line 32 and the pixel electrode 13. The second data line 32 and the first data line 31 are at least partially overlapped in a direction perpendicular to the substrate 1, the pixel electrode 13 is connected to the first drain electrode 101 via a through hole 16 in the first insulating layer 14 and connected to the second drain electrode 102 via a through hole 15 in the first insulating layer 14, the second data line 32 is connected to the second source electrode 92 via a through hole 15 in the first insulating layer 14, as shown in FIG. 3-6.

Since the data lines are overlapped in the array substrate manufactured by the present embodiment, the area of data lines covered by the black matrix can be reduced, thus improving the aperture ratio and display quality of the LCD.

The step A700 can further comprise following steps:

step A701, a metal layer is deposited on the first insulating layer 14 and etched in a patterning process to form the second data line 32, the second data line 32 and the first data line 31 are at least partially overlapped in a direction perpendicular to the substrate 1, the second data line is connected to the second source electrode 92 via a through hole 15 in the first insulating layer 14;

step A702, a second passivation layer 19 is deposited on the substrate 1, covering the second data line 32, and through holes 16 and 17 are formed in the second passivation layer corresponding to the first drain electrode and the second drain electrode, respectively;

step A703, a transparent conductive layer is deposited on the second passivation layer 19;

step A704, the transparent conductive layer is etched in a patterning process to form a pixel electrode 13, the pixel electrode 13 is connected to the first drain electrode 101 and the second drain electrode 102 via the through holes in the first insulating layer 14 and the second passivation layer 19, as shown in FIGS. 11 and 12.

The above method can be also applied to manufacture the array substrate according to the third embodiment. Since the data lines are overlapped in the array substrate, the area of data lines covered by the black matrix can be reduced, thus improving the aperture ratio and display quality of the LCD.

Second Embodiment of Manufacturing Method of an Array Substrate

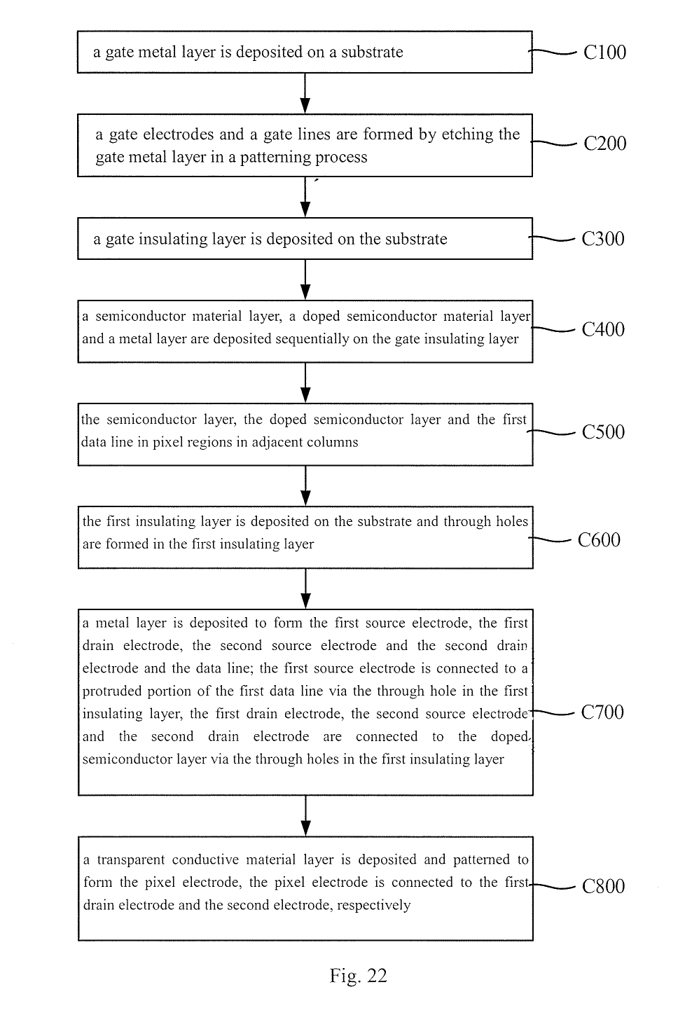

FIG. 22 is a flow chart of a second embodiment of a manufacturing method of an array substrate according to the present invention. The method can be applied to manufacture the array substrate according to the second embodiment. As shown in FIG. 7-10, the method can comprise following steps:

step C100, a gate metal layer is deposited on substrate 1;

step C200, the gate metal layer is etched in a patterning process to form the gate electrode and the gate line 2;

step C300, a gate insulating layer 6 is deposited on the substrate 1;

step C400, a semiconductor material layer, a doped semiconductor material layer and a metal layer are deposited sequentially on the gate insulating layer 6;

step C500, the semiconductor material layer, the doped semiconductor material layer and the metal layer are etched in a patterning process to form the semiconductor layer 7, the doped semiconductor layer 8 and the first data line 31 in pixel regions in adjacent columns, the first data line 31 is formed between the pixel regions in adjacent columns, and the first data line 31 can extend onto the doped semiconductor layer 8;

step C600, a first insulating layer 14 is deposited on the substrate 1 and through holes 18, 16, 15 and 17 are formed in the first insulating layer 14 corresponding to the first source electrode, the first drain electrode, the second source electrode and the second drain electrode, respectively;

step C700, a metal layer is deposited on the first insulating layer 14 and patterned to form the first source electrode 91, the first drain electrode 101, the second source electrode 92 and the second drain electrode 102 and the data line 32; the first source electrode 91 is connected to a protruded portion of the first data line 31 via the through hole 18 in the first insulating layer 14, the first drain electrode 101, the second source electrode 92 and the second drain electrode 102 are connected to the doped semiconductor layer 8 via the through holes 16, 15 and 17, the second data line 32 and the first data line 31 are partially overlapped in a direction perpendicular to the substrate 1, and the first source electrode 91 and the second source electrode 92 are disposed on both sides of the second data line 32, respectively;

step C800, a transparent conductive material layer is deposited and patterned to form the pixel electrode 13, the pixel electrode is connected to the first drain electrode 101 and the second electrode 102, respectively.

Third Embodiment of Manufacturing Method of an Array Substrate

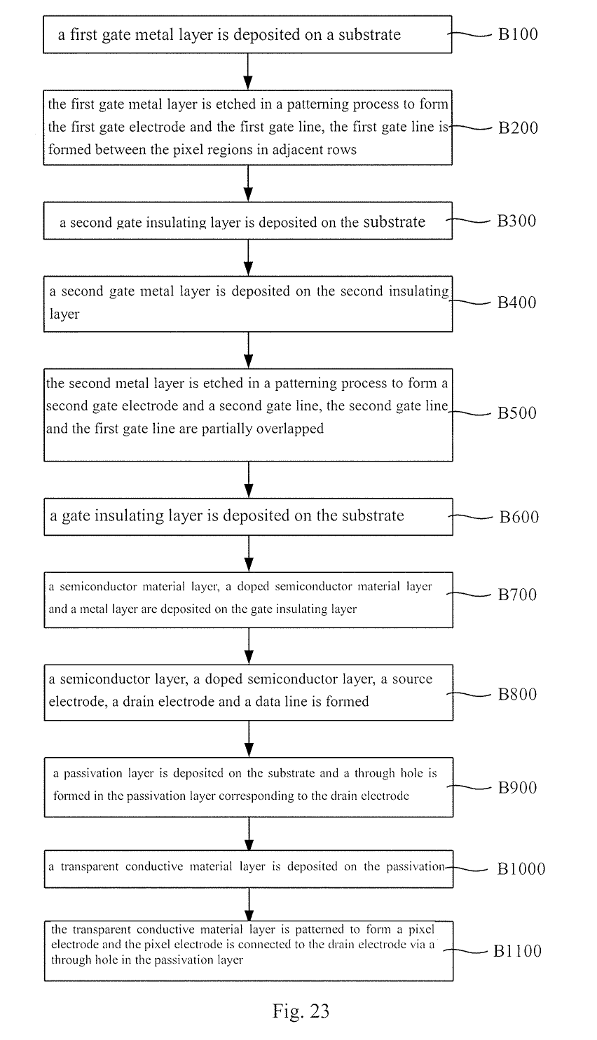

FIG. 23 is a flow chart of a third embodiment of a manufacturing method of an array substrate according to the present invention. The method can be applied to manufacture the array substrate as shown in FIGS. 13 and 14, and the method can comprise following steps:

step B100, a first gate metal layer is deposited on a substrate 1;

step B200, the first gate metal layer is etched in a patterning process to form the first gate electrode 41 and the first gate line 21, the first gate line 21 is formed between the pixel regions in adjacent rows;

step B300, a second gate insulating layer 6 is deposited on the substrate 1;

step B400, a second gate metal layer is deposited on the second insulating layer 61;

step B500, the second metal layer is etched in a patterning process to form a second gate electrode 32 and a second gate line 22, the second gate line 22 and the first gate line 21 are partially overlapped in a direction perpendicular to the substrate 1;

step B600, a gate insulating layer 6 is deposited on the substrate 1;

step B700, a semiconductor material layer, a doped semiconductor material layer and a metal layer are deposited on the gate insulating layer 6;

step B800, the semiconductor material layer, the doped semiconductor material layer and the metal layer are etched in a patterning process to form a semiconductor layer 7, a doped semiconductor layer 8, a source electrode 9, a drain electrode 10 and a data line 3;

step B900, a passivation layer 11 is deposited on the substrate 1 and a through hole 12 is formed in the passivation layer 11 corresponding to the drain electrode 10;

step B1000, a transparent conductive material layer is deposited on the passivation layer 11;

step B1100, the transparent conductive material layer is etched in a patterning process to form a pixel electrode 12 and the pixel electrode 13 is connected to the drain electrode 10 via a through hole 12 in the passivation layer.

The above method can be also applied to manufacture the array substrate according to the fourth embodiment. Since the data lines and/or gate lines are overlapped in the array substrate, the area of data lines and/or gate lines covered by the black matrix can be reduced, thus improving the aperture ratio and display quality of the LCD.

Fourth Embodiment of Manufacturing Method of an Array Substrate

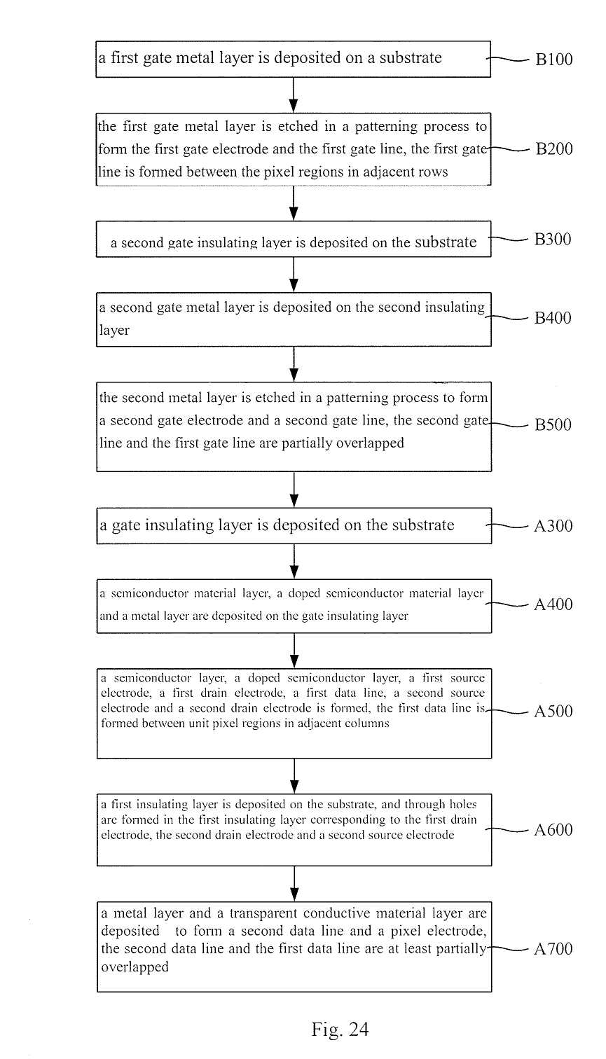

FIG. 24 is a flow chart of a fourth embodiment of a manufacturing method of an array substrate according to the present invention. The method can be applied to manufacture the array substrate as shown in FIG. 14, and the method combines the first and the third embodiment of the manufacturing method and can comprise following steps:

step B100, a first gate metal layer is deposited on a substrate;

step B200, the first gate metal layer is etched in a patterning process to form the first gate electrode and the first gate line, the first gate line is formed between the pixel regions in adjacent rows;

step B300, a second insulating layer is deposited on the substrate;

step B400, a second gate metal layer is deposited on the second insulating layer;

step B500, the second metal layer is etched in a patterning process to form a second gate electrode and a second gate line, the second gate line and the first gate line are partially overlapped in a direction perpendicular to the substrate 1;

step A300, a gate insulating layer is deposited on the substrate;

step A400, a semiconductor material layer, a doped semiconductor material layer and a metal layer are deposited on the gate insulating layer;

step A500, the semiconductor material layer, the doped semiconductor material layer and the metal layer are patterned by etching so as to form a semiconductor layer, a doped semiconductor layer, a first source electrode, a first drain electrode, a first data line, a second source electrode and a second drain electrode; the first data line is formed between unit pixel regions in adjacent columns, a first source electrode is connected to the first data line;

step A600, a first insulating layer is deposited on the substrate, then through holes are formed in the first insulating layer corresponding to the first drain electrode, the second drain electrode and a second source electrode, respectively; and

step A700, a metal layer and a transparent conductive material layer can be sequentially deposited on the first insulating layer, and a second data line and a pixel electrode can be formed by etching in two separate patterning processes; alternatively, a transparent conductive material layer and a metal layer can be sequentially deposited and patterned to form the second data line and the pixel electrode, the pixel electrode is connected to the first drain electrode and the second drain electrode via through holes in the first insulating layer and the second passivation layer, respectively.

Array substrates according to the embodiments of the present invention and array substrates manufactured by the embodiments of the present invention can have improved aperture ratio. For example, in case of 19 inch wide LCD, if width of the data lines is about 5.5 mm, the aperture ratio of the LCD can be improved by approximately 15%.

Liquid Crystal Display Panel

A liquid crystal display panel according to the present invention can comprise an array substrate according to any one of the embodiments discussed above, a color filter substrate and a liquid crystal layer filled therebetween. The array substrate and the color filter substrate are assembled. A black matrix is disposed on the color filter substrate. The black matrix can comprise a plurality of first light blocking bars and a plurality of second light blocking bars alternatively disposed. The first bars are disposed above the data lines and/or the gate lines, so that the width of the first bars can be larger than the second bars without underlying the data lines and/or the gate lines.

In a conventional LCD device, the black matrix is made of a plurality of light blocking bars crossing each other, and blocking bars of the black matrix have a width corresponding to the width of the data lines and/or the gate lines. Since in the embodiments of the present invention, there is either two overlapped data lines or gate lines or no data lines or gate lines between two pixel electrode in adjacent lines of pixel region matrix, it is possible to form blocking bars of the black matrix with reduced width on a portion of color filter substrate where there is no data lines or gate lines disposed between pixel electrodes.

Since the data lines and/or gate lines are overlapped in the array substrate, the area of data lines and/or gate lines covered by the black matrix can be reduced, thus improving the aperture ratio and display quality of the LCD.

The invention being thus described, it will be obvious that the same may be varied in many ways. Such variations are not to be regarded as a departure from the spirit and scope of the invention, and all such modifications as would be obvious to those skilled in the art are intended to be included within the scope of the following claims.

What is claimed is:

1. An array substrate, comprising
a substrate;
a plurality of pixel regions in a matrix arrangement on the substrate, each pixel region comprising a pixel electrode and a drive switch; and
a plurality of signal lines disposed on the substrate and extended parallel to each other;
wherein at least part of a first signal line and a second signal line of the plurality of the signal lines connected to pixel electrodes in adjacent lines of the pixel region matrix are formed between the pixel electrodes in adjacent lines of the pixel regions matrix, the first signal line and the second signal line are at least partially overlapped in a direction perpendicular to the substrate, an insulating layer is disposed between the overlapped portion of the first and second signal line.

2. The array substrate according to claim 1, wherein the signal lines are data lines, the first and second signal line are a first and second data line connected to pixel electrodes in adjacent columns of the pixel region matrix, and the insulating layer is a first insulating layer.

3. The array substrate according to claim 2, wherein the first data line is at least partially disposed below the second data line;
the pixel electrode is formed above the first insulating layer and the second data line; and
the array substrate further comprises a second passivation layer formed above the first insulating layer and covering the second data line.

4. The array substrate according to claim 2, wherein the first data line and the second data line are formed above a gate insulating layer of the drive switch; and
the first data line is formed in a same layer as a source electrode of the drive switch connected thereto, the second data line is formed in a same layer as a source electrode of the drive switch connected thereto.

5. The array substrate according to claim 2, further comprising a plurality of gate lines crossing the plurality of data lines, at least part of a first gate line and a second gate line of the plurality of the gate lines connected to pixel electrodes in adjacent rows of the pixel region matrix are formed between the pixel electrodes in adjacent rows of the pixel region matrix, the first gate line and the second gate line are at least partially overlapped in a direction perpendicular to the substrate, a second insulating layer is disposed between the overlapped portion of the first and second gate line.

6. The array substrate according to claim 5, wherein the first gate line and the second line are covered by a gate insulating film.

7. The array substrate according to claim 5, wherein the first gate line is formed in a same layer as a gate electrode of the drive switch connected thereto, the second gate line is formed in a same layer as a gate electrode of the drive switch connected thereto.

8. The array substrate according to claim 1, wherein the signal lines are gate lines, the first and second signal line are a first and second gate line connected to pixel electrodes in adjacent rows of the pixel region matrix, and the insulating layer is a second insulating layer.

9. The array substrate according to claim 8, wherein the first gate line and the second line are covered by a gate insulating film.

10. The array substrate according to claim 8, wherein the first gate line and the second line are formed in a same layer as a gate electrode of drive switch.

11. A liquid crystal display (LCD) panel, comprising:
an array substrate, comprising a substrate; a plurality of pixel regions in a matrix arrangement on the substrate, each pixel region comprising a pixel electrode and a drive switch; a plurality of signal lines disposed on the substrate and extended parallel to each other;
wherein at least part of a first signal line and a second signal line of the plurality of the signal lines connected to pixel electrodes in adjacent lines of the pixel region matrix are formed between the pixel electrodes in adjacent lines of the pixel regions matrix, the first signal line and the second signal line are at least partially overlapped in a direction perpendicular to the substrate, an insulating layer is disposed between the overlapped portion of the first and second signal line;
a color filter substrate with a black matrix disposed thereon, and
a liquid crystal layer filled between the array substrate and the color filter substrate.

12. The LCD panel according to claim 11, wherein the black matrix comprises a plurality of first light blocking bars and a plurality of second light blocking bars alternatively disposed, the first bars are disposed above the signal lines, so that the width of the first bars is larger than the second bars without underlying the signal lines.

13. The LCD panel according to claim 11, wherein the signal lines are data lines, the first and second signal line are a first and second data line connected to pixel electrodes in adjacent columns of the pixel region matrix, and the insulating layer is a first insulating layer.

14. The LCD panel according to claim 13, wherein the first data line is at least partially disposed below the second data line;
the pixel electrode is formed above the first insulating layer and the second data line; and
the array substrate further comprises a second passivation layer formed above the first insulating layer and covering the second data line.

15. The LCD panel according to claim 13, wherein the first data line and the second data line are formed above a gate insulating layer of the drive switch; and
the first data line is formed in a same layer as a source electrode of the drive switch connected thereto, the second data line is formed in a same layer as a source electrode of the drive switch connected thereto.

16. The LCD panel according to claim 13, further comprising a plurality of gate lines crossing the plurality of data lines, at least part of a first gate line and a second gate line of the plurality of the gate lines connected to pixel electrodes in adjacent rows of the pixel region matrix are formed between the pixel electrodes in adjacent rows of the pixel region matrix, the first gate line and the second gate line are at least partially overlapped in a direction perpendicular to the substrate, a second insulating layer is disposed between the overlapped portion of the first and second gate line.

17. The LCD panel according to claim 16, wherein the first gate line is formed in a same layer as a gate electrode of the drive switch connected thereto, the second gate line is formed in a same layer as a gate electrode of the drive switch connected thereto.

18. The LCD panel according to claim 11, wherein the signal lines are gate lines, the first and second signal line are a first and second gate line connected to pixel electrodes in adjacent rows of the pixel region matrix, and the insulating layer is a second insulating layer.

19. The LCD panel according to claim 18, wherein the first gate line and the second line are formed in a same layer as a gate electrode of drive switch.
